(19) United States
(12) Patent Application Publication
(10) Pub. No.: US 2006/0242635 A1
(43) Pub. Date: Oct. 26, 2006

(54) Method and system for optimizing array sizes in a JAVA virtual machine

(76) Inventors: Scott Broussard, Cedar Park, TX (US); Eduardo Spring, Round Rock, TX (US)

Correspondence Address: IBM CORP. (MRN);c/o LAW OFFICE OF MICHAEL R. NICHOLS, 3001 S. HARDIN BLVD., STE. 110, PMB 155, MCKINNEY, TX, 75070-7702, US

(21) Appl. No.: 11/111,512

(22) Filed: Apr. 21, 2005

(51) Int. Cl. G06F 9/45

(52) U.S. Cl. 717/151

(57) ABSTRACT

A method, computer program product, and data processing system for allocating memory for arrays in a fragmented heap is disclosed. In a preferred embodiment, a JAVA virtual machine (JVM) is enhanced to organize each array as an array of arrays (or, internally, an array of pointers to arrays, since JAVA arrays are reference types). The individual “inner arrays” within the “outer array” are segments that collectively simulate a larger “virtual array.” Because all accesses and allocations of these arrays are performed by the JAVA virtual machine, the array segmentation is entirely transparent to the programmer, at least at the JAVA-language level. Support for native methods is provided by making relatively minor modifications to some of the array manipulation functions of the JAVA Native Interface (JNI), so as to minimize the impact of the segmentation scheme on native code.

### BACKGROUND OF THE INVENTION

1. Technical Field

The present invention relates generally to memory management in a virtual machine. Specifically, the present invention provides a method of dynamically dividing arrays into pieces to allow memory for those arrays to be allocated from a fragmented heap.

2. Description of the Related Art

JAVA is an object-oriented, compiled, multi-threaded computer language that generates platform-independent executable files.

JAVA is object-oriented. This means, in the simplest terms, that it allows for the association of member functions or “methods” within data structures. Indeed, all JAVA programs are made up solely of data structure types known as “classes,” where classes contain both data fields and methods.

Classes may “inherit” characteristics of other classes. When a “descendant” class inherits from another “ancestral” class, it inherits all of the data fields and methods of the ancestral class. In addition, a descendent class may provide its own methods to supplement or take the place of ancestral class methods.

JAVA is compiled. That means that before a JAVA program (written as source code) can be executed, it must be processed by a compiler to make an executable form of the program. Executable JAVA programs are stored in “.class” files, with each “.class” file containing executable object code for a single JAVA class.

JAVA is multi-threaded. This means that a single JAVA program can have several sequences of code executing concurrently. Each of these sequences is known as a thread. Multi-threaded program languages, such as JAVA, are very useful when writing software such as, for instance, communication software, where it is helpful to allow the software to perform other tasks while waiting for input.

JAVA produces platform-independent executables. When a JAVA program is compiled to produce “.class” files, those “.class” files are capable of being executed on any platform having a JAVA runtime environment. A JAVA runtime environment is a piece of software that allows a computer to execute JAVA “.class” files. JAVA runtime environments are available for many, if not most, commonly used computer platforms today.

There are essentially two kinds of JAVA runtime environments: interpreters and just-in-time compilers. Interpreters directly interpret the binary code contained in “.class” files and execute instructions corresponding to that binary code as the interpretation process is carried out. Just-in-time compilers, on the other hand, first translate the binary code into native instructions, then execute the native instructions. Native instructions are instructions that are designed to be executed directly by the computer's hardware.

Because JAVA generates executable files containing platform-independent instructions, it does not generally support operations that are primarily hardware-specific. For this reason, JAVA includes a scheme for executing methods written using (non-JAVA) native instructions, the JAVA Native Interface (or JNI). Methods written using native instructions are known as “native methods.” In theory, native methods can be written using any language that compiles into native instructions, such as C, C++, or Fortran. In practice, however, generally only C and C++ are used to implement native methods. The JNI is described in detail in LIANG, Sheng. The Java Native Interface: Programmer's Guide and Specification. Reading, MA: Addison-Wesley, 1999. ISBN 0201325772, which is incorporated herein by reference in its entirety.

Although native methods are useful when platform-dependent operations must be performed, native methods have other uses as well. Program code written with native instructions generally executes at a higher speed than program code written with JAVA's platform-independent instructions. Also, using native methods allows JAVA programmers to reuse already-existing non-JAVA code in their JAVA programs.

To use native methods in a JAVA class, one places native method declarations in the JAVA source code to the class, then compiles native methods in the other language (C, C++, etc.) into a dynamically-linked library (DLL). When the JAVA class is loaded by a JAVA runtime environment, the DLL is also loaded, and the native methods may be executed, just as if they had been written in JAVA.

The Java virtual machine, like most runtime environments for high-level languages, utilizes a heap to dynamically allocate memory objects such as arrays and object instances. In the heap, as the term is used in the context of runtime environments for high-level languages, regions of memory space are allocated consecutively, and allocated memory regions are “piled,” one on top of the other, on the top of the heap. Over time, as some memory regions are no longer needed, those regions are deallocated. In many runtime environments, including the Java virtual machine, a “garbage collector” is used to reclaim the unneeded space. When some memory regions have been deallocated, while others have not, a fragmented heap can arise, as depicted in FIG. 1. FIG. 1 shows a heap space 100, which contains allocated memory regions 102, 104, and 106 and unallocated memory regions 108, 110, and 112. When the heap is fragmented in this way, the total amount of available heap space exceeds the largest contiguous block of free space. This may prevent a program from being able to allocate memory for large arrays. In order to reclaim the memory space and make it available for allocating large data structures, a garbage collector is used to compact the allocated memory into a contiguous block, thereby consolidating the unallocated memory for future use.

In certain runtime environments where concurrency and/or real-time operation are supported, such as the Java virtual machine, certain allocated memory regions may be “pinned,” meaning that that memory region may not be relocated by the garbage collector. Obviously, when this situation arises, the garbage collector's task is frustrated. If pinned memory regions prevent a fragmented heap from being compacted, a request to allocate a large array may fail with an “out of memory” error, even if there is sufficient free memory to support the request, since it may not be possible to allocate a sufficiently large contiguous block of memory to satisfy the request. This is a particularly troublesome sort of error, because it is extremely difficult to trigger predictably, and hence, it is also extremely difficult to identify in testing and debugging of the software.

What is needed, therefore, is a transparent method of optimizing array allocations to reduce the incidence of “out of memory” errors due to fragmented heaps. The present invention provides a solution to these and other problems, and offers other advantages over previous solutions.

### SUMMARY OF THE INVENTION

The present invention provides a method, computer program product, and data processing system for allocating memory for arrays in a fragmented heap. In a preferred embodiment, a JAVA virtual machine (JVM) is enhanced to organize each array as an array of arrays (or, internally, an array of pointers to arrays, since JAVA arrays are reference types). The individual “inner arrays” within the “outer array” are segments that collectively simulate a larger “virtual array.” Because all accesses and allocations of these arrays are performed by the JAVA virtual machine, the array segmentation is entirely transparent to the programmer, at least at the JAVA-language level. Support for native methods is provided by making relatively minor modifications to some of the array manipulation functions of the JAVA Native Interface (JNI), so as to minimize the impact of the segmentation scheme on native code.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a diagram illustrating the phenomenon of a fragmented heap;

FIG. 2 is a diagram providing a general overview of the data structures involved in allocating an array in accordance with a preferred embodiment of the present invention;

FIG. 3 is a flowchart representation of a process of creating an array in accordance with a preferred embodiment of the present invention; and

FIG. 4 is a block diagram of a data processing system in which a preferred embodiment of the present invention may be implemented.

### DETAILED DESCRIPTION

The following is intended to provide a detailed description of an example of the invention and should not be taken to be limiting of the invention itself. Rather, any number of variations may fall within the scope of the invention, which is defined in the claims following the description.

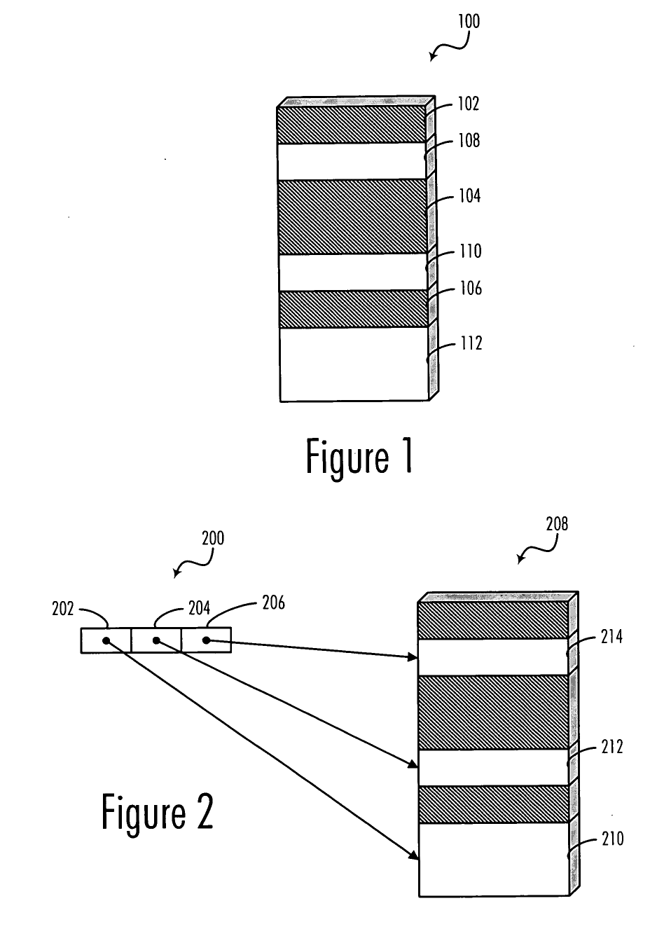

FIG. 2 illustrates the main concepts of the array allocation method employed by JAVA virtual machine implemented in accordance with a preferred embodiment of the present invention. Rather than allocating a single contiguous array in response to a dynamic array allocation request, a preferred embodiment of the present invention actually allocates a plurality of arrays, an outer array 200 and one or more inner arrays (represented here by memory regions 210, 212, and 214 in heap 208), which collectively make up the full array. It should be noted that outer array 200, like inner arrays 210, 212, and 214, is also allocated on heap 208.

Each of the elements of outer array 200 (elements 202, 204, and 206) contains a reference to a corresponding inner array (inner arrays 210, 212, and 214, respectively). These references are arranged in order in outer array 200 so that, for example, element 202 points to inner array, which contains elements 1, 2, . . . , N of the full “virtual array, while the next element in outer array 200, element 204, points to inner array 212, which contains elements N+1, N+2, . . . , P, and so forth.

Thus, when a large heap request is issued to the JVM, such that there is no block of contiguous free space in the heap that is sufficiently large enough in and of itself to satisfy the request, the JVM can identify a number of blocks of free space that, collectively, contain enough space to satisfy the request. Those blocks can then be allocated on the heap as inner arrays. The JVM also allocates an outer array of length X on the heap, where X is the number of inner arrays. A reference to each inner array is then stored in each element of the outer array.

In the event that a heap request can be satisfied with a contiguous block of memory in the heap, the same inner and outer array arrangement is utilized. However, in that case, there is only one element in the outer array, a single reference to a single inner array. This allows for consistency among dynamically-allocated arrays.

Because this scheme is implemented within the JVM, it is entirely transparent to the programmer who utilizes only JAVA code. A preferred embodiment of the present invention, however, also supports dynamic allocation within native methods. With a minimal loss of transparency, a preferred embodiment of the present invention provides some minor changes to the JAVA Native Interface (JNI) to allow for array segmentation.

In the version 1.4 reference implementation of JAVA, from Sun Microsystems, Inc., the C/C++ header file “jni.ho describes, in terms of the C and C++ languages, the JAVA Object Model and the operations that are available on JAVA objects. JAVA arrays are implemented as instances of the C++ class “_jarray,” which is descended from the base type of all JAVA objects, “_jobject.” In accordance with the JNI's naming conventions, pointer to the C++class “_jarray” is typecast into the C type “jarray.” JNI defines a number of functions C/C++ functions that are used to manipulate JAVA arrays from within C/C++ code. To maximize compatibility with existing JNI-based code, the present invention provides functions providing the same essential functionality with the same or minimally modified interface. The most important of these are listed in Table 1, below.

TABLE 1

| Function Name | Action Function Performs |
|---|---|
| GetArrayLength | Returns the total number of elements in |
| | a given “virtual array.” (as the sum of |
| | the lengths of the inner arrays) |
| NewObjectArray/ | Allocates a new virtual array of JAVA |
| NewXXXArray (where | objects or of values of type XXX. By |
| XXX is a primitive | default, this means a single inner array |
| type, such as | pointed to by a single-element outer |
| “int” or “char”) | array. However, if not enough memory |
| | exists, more inner arrays and more outer |
| | array elements may be allocated. In a |
| | preferred embodiment, a constant |
| | JNI_MIN_FRAGMENT_SIZE may be |
| | defined in jni.h, so that arrays |
| | smaller than the size |
| | JNI_MIN_FRAGMENT_SIZE may never |
| | become segmented. This allows code that |
| | deals only with small arrays to be |
| | simplified. |
| GetObjectArrayElement/ | Gets or sets (respectively) a value of a |
| SetObjectArrayElement | particular element in a virtual array. |
| GetXXXArrayRegion | Returns a portion (region) of a given |
| (where XXX is a | array. |
| primitive type, such | |
| as “int” or “char”) | |
| GetXXXArrayElements | Returns a pointer to the “raw” |
| (where XXX is a | contents of an array. |
| primitive type, such | |
| as “int” or | |
| “char”) | |
| GetPrimitiveArrayCritical | Returns a pointer to the “raw” |
| | contents of an array, while causing |
| | the JVM to enter into a “critical |
| | region,” for purposes of |
| | concurrency control. |
| GetStringCritical | Returns a pointer to the “raw” |
| | contents of a character string, |
| | while causing the JVM to enter into |
| | a “critical region,” for |
| | purposes of concurrency control. |

Of the above functions, the interfaces (i.e., function signatures or prototypes) of only the three “raw contents” types of functions, i.e., the GetXXXArrayElements functions and the GetPrimitiveArrayCritical and GetStringCritical functions require modifications to support segmented arrays. Specifically, rather than returning a pointer to the entire (virtual) array, these functions each return a pointer to the particular inner array (segment) being accessed each of the functions requires two additional parameters, an index parameter to specify to select which inner array (segment) is going to be accessed (i.e., an index into the outer array) and an output parameter for allowing the length of the segment being examined to be returned. Thus, in the case of “GetBooleanArrayElements,” the standard JNI function signature/prototype found in “jni.h”:
jboolean*(JNICALL*GetBooleanArrayElements)(JNIEnv*env, jbooleanArray array, jboolean*isCopy);
is replaced with:
jboolean*(JNICALL*GetBooleanArrayElements)(JNIEnv*env, jbooleanArray array, jboolean*isCopy, jint segment, jint*length);

To facilitate the use of these “raw array” functions, an additional function, “GetArraySegments,” is provided. GetArraySegments returns, as a JAVA integer (type “jint”), the number of segments (inner arrays) defined for a given virtual array. The full C/C++ function prototype is defined as
jint (JNICALL*GetArraySegments)(JNIEnv*env, jarray array);
where “env” is a pointer to the current JNI environment (see above-cited LIANG reference for further details) and “array” is the virtual array for which a count of the number of segments is desired. GetArraySegments facilitates the use of the “raw array” functions, since it allows a program that needs to access the raw data of a multi-segment array to determine how many segments need to be accessed by that program in order to traverse the entire virtual array.

Since, in some contexts where program correctness outweighs performance, it can be considered bad programming practice to operate on raw arrays of primitive types, it is contemplated that many programmers will have no need to use these modified “raw array” functions. Thus, one of ordinary skill in the art will recognize that the allocation scheme employed by a preferred embodiment of the present invention will, for the most part, be transparent to the programmer in JNI code, as well.

One of ordinary skill in the art will recognize that the fundamental teachings of the present invention may be applied in a number of contexts, including outside of the JAVA programming sphere. For example, other languages, such as certain implementations of Prolog that make use of the Warren Abstract Machine (WAM), rely on their own virtual machines and must also perform dynamic memory allocation and garbage collection (as a side note, another term that is synonymous with “virtual machine” is “abstract machine”). Interpreted high-level languages, such as Lisp or Scheme, may also apply this approach. And in certain circumstances where “pointer safety” can be assured, even certain native-code-compiled languages may apply the present invention's techniques of substantially transparent array segmentation (through carefully constructed library functions, for example). Thus, the present invention should not be interpreted as being in any way limited to the JAVA language or JAVA runtime environment.

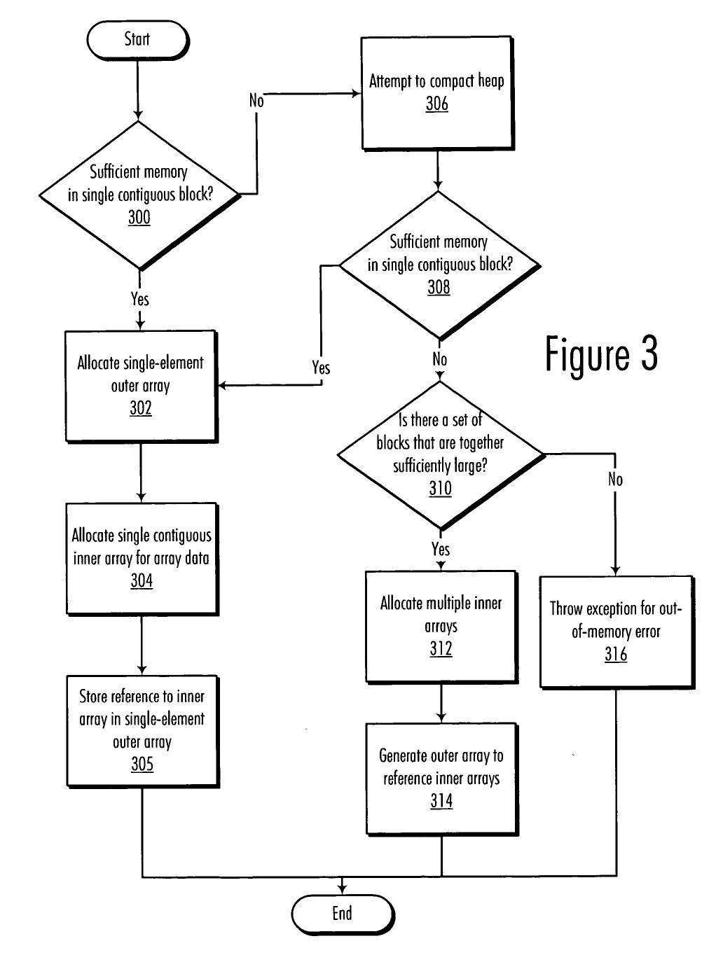

FIG. 3 is a flowchart representation of a process of servicing a dynamic memory allocation request for an array in accordance with a preferred embodiment of the present invention. Upon commencement of servicing the request, the runtime environment (e.g., JAVA virtual machine) determines if sufficient memory exists in a single contiguous block of memory to allow the desired memory to be allocated in one contiguous block (block 300). If so (block 300:yes), the runtime environment allocates a single-element outer array (block 302) and a single contiguous inner array (block 304), and the outer array element is set to reference the single inner array (block 305).

If not (block 300:no), then an attempt is made to compact the heap so as to consolidate free space (block 306). A determination is then made as to whether sufficient memory now exists in a single contiguous block of memory to allow the desired memory to be allocated in one contiguous block (block 308). If so, (block 308:yes), the runtime environment allocates a single-element outer array (block 302) and a single contiguous inner array (block 304). The runtime environment then sets the outer array element to reference the single inner array (block 305).

If not (block 308:no), a determination is then made as to whether there exist a set of blocks of free memory space that, collectively, contain enough memory to satisfy the request (block 310). If there is such a set of memory blocks (block 310:yes), then those memory blocks (or whatever portions of those block are needed) are allocated as inner arrays (block 312) and an outer array is generated to reference each of the inner arrays (block 314). If, on the other hand, no such set of memory blocks can be found (block 310:no), an exception is thrown to signal an out-of-memory (fatal) error (block 316).

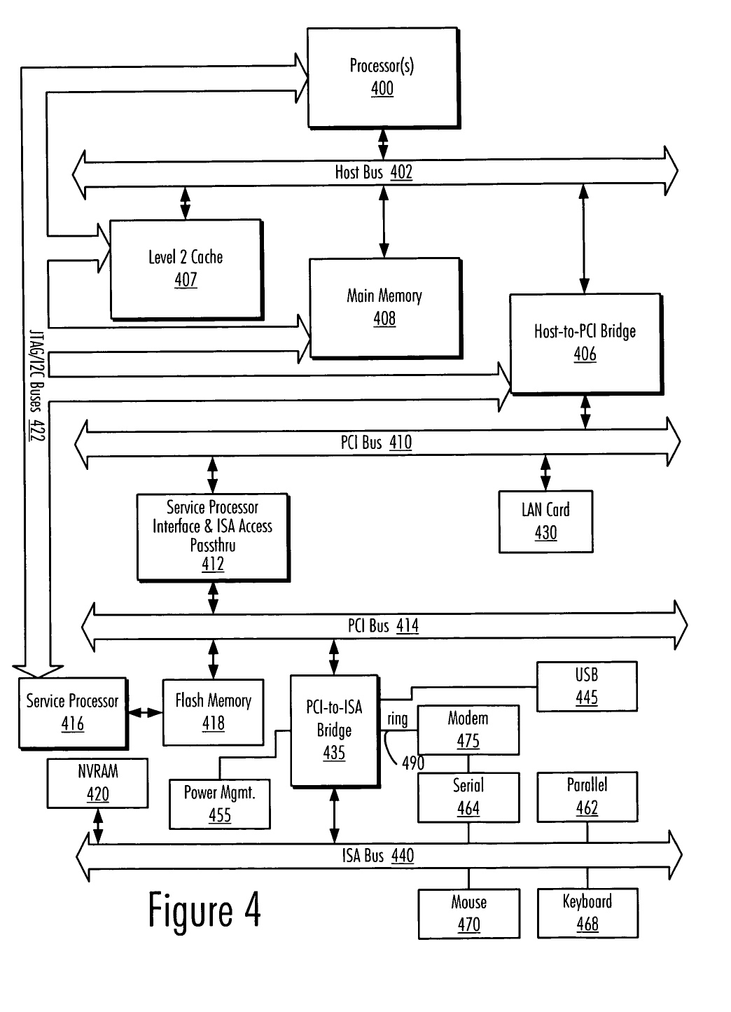

FIG. 4 illustrates information handling system 401, which is a simplified example of a computer system capable of performing the computing operations of the host computer described herein with respect to a preferred embodiment of the present invention. Computer system 401 includes processor 400 which is coupled to host bus 402. A level two (L2) cache memory 404 is also coupled to host bus 402. Host-to-PCI bridge 406 is coupled to main memory 408, includes cache memory and main memory control functions, and provides bus control to handle transfers among PCI bus 410, processor 400, L2 cache 404, main memory 408, and host bus 402. Main memory 408 is coupled to Host-to-PCI bridge 406 as well as host bus 402. Devices used solely by host processor(s) 400, such as LAN card 430, are coupled to PCI bus 410. Service Processor Interface and ISA Access Pass-through 412 provides an interface between PCI bus 410 and PCI bus 414. In this manner, PCI bus 414 is insulated from PCI bus 410. Devices, such as flash memory 418, are coupled to PCI bus 414. In one implementation, flash memory 418 includes BIOS code that incorporates the necessary processor executable code for a variety of low-level system functions and system boot functions.

PCI bus 414 provides an interface for a variety of devices that are shared by host processor(s) 400 and Service Processor 416 including, for example, flash memory 418. PCI-to-ISA bridge 435 provides bus control to handle transfers between PCI bus 414 and ISA bus 440, universal serial bus (USB) functionality 445, power management functionality 455, and can include other functional elements not shown, such as a real-time clock (RTC), DMA control, interrupt support, and system management bus support. Nonvolatile RAM 420 is attached to ISA Bus 440. Service Processor 416 includes JTAG and I2C buses 422 for communication with processor(s) 400 during initialization steps. JTAG/I2C buses 422 are also coupled to L2 cache 404, Host-to-PCI bridge 406, and main memory 408 providing a communications path between the processor, the Service Processor, the L2 cache, the Host-to-PCI bridge, and the main memory. Service Processor 416 also has access to system power resources for powering down information handling device 401.

Peripheral devices and input/output (I/O) devices can be attached to various interfaces (e.g., parallel interface 462, serial interface 464, keyboard interface 468, and mouse interface 470 coupled to ISA bus 440. Alternatively, many I/O devices can be accommodated by a super I/O controller (not shown) attached to ISA bus 440.

In order to attach computer system 401 to another computer system to copy files over a network, LAN card 430 is coupled to PCI bus 410. Similarly, to connect computer system 401 to an ISP to connect to the Internet using a telephone line connection, modem 475 is connected to serial port 464 and PCI-to-ISA Bridge 435.

While the computer system described in FIG. 4 is capable of supporting the instruction set architecture described herein, this computer system is simply one example of a computer system. Those skilled in the art will appreciate that many other computer system designs are capable of performing the processes described herein.

Particular aspects and possible embodiments of the invention fall within the realm of software. In particular, to utilize the features of a preferred embodiment of the present invention, one must execute software containing estimate instructions in accordance with the teachings of the present invention. An embodiment of the present invention may also include or take the form of microcode, which is software that is internal to the processor and that specifies some of the detailed control steps needed to perform an instruction.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an;” the same holds true for the use in the claims of definite articles.

What is claimed is:

1. A computer-based method comprising:
executing a virtual machine instruction to dynamically allocate an array of memory in a heap, wherein the executing includes:
identifying a set of one or more blocks of free memory space, wherein each block in the set is a contiguous region of free memory space and wherein the set of blocks, collectively, has a total amount of free memory space that is at least as large as the array to be allocated;
allocating one or more inner arrays from the identified blocks;
allocating an outer array having at least as many elements as the number of inner arrays allocated; and
recording references to the inner arrays in the outer array.

2. The method of claim 1, further comprising:
determining if there exists a single block of memory within the heap such that the single block itself has an amount of free memory space that is at least as large as the array to be allocated; and
including only the single block of memory in said set of blocks in response to a determination that such single block exists.

3. The method of claim 2, further comprising:
compacting the heap in response to a determination that such single block does not exist.

4. The method of claim 3, further comprising:
performing said identifying after compacting the heap.

5. The method of claim 4, further comprising:
in response to said identifying's resulting in failure, raising an error condition.

6. The method of claim 1, wherein the virtual machine instruction is performed in a JAVA virtual machine.

7. The method of claim 6, further comprising:
accessing, from within a native method, one or more elements from the one or more inner arrays.

8. A computer program product in a computer-readable medium, comprising functional descriptive material that, when executed by a computer, causes the computer to perform actions that include:
invoking an interface to direct the computer to dynamically allocate an array of memory in a heap, wherein allocating the array includes:
identifying a set of one or more blocks of free memory space, wherein each block in the set is a contiguous region of free memory space and wherein the set of blocks, collectively, has a total amount of free memory space that is at least as large as the array to be allocated;
allocating one or more inner arrays from the identified blocks;
allocating an outer array having at least as many elements as the number of inner arrays allocated;
recording references to the inner arrays in the outer array, and
wherein the interface bears no indication as to whether the array is allocated as a segmented array or as a single, contiguously stored array.

9. The computer program product of claim 8, comprising additional functional descriptive material that, when executed by the computer, directs the computer to perform actions of:
determining if there exists a single block of memory within the heap such that the single block itself has an amount of free memory space that is at least as large as the array to be allocated; and
including only the single block of memory in said set of blocks in response to a determination that such single block exists.

10. The computer program product of claim 9, comprising additional functional descriptive material that, when executed by the computer, directs the computer to perform actions of:
compacting the heap in response to a determination that such single block does not exist.

11. The computer program product of claim 10, comprising additional functional descriptive material that, when executed by the computer, directs the computer to perform actions of:
performing said identifying after compacting the heap.

12. The computer program product of claim 11, comprising additional functional descriptive material that, when executed by the computer, directs the computer to perform actions of:
in response to said identifying's resulting in failure, raising an error condition.

13. The computer program product of claim 8, wherein the interface is an instruction in a JAVA virtual machine.

14. The computer program product of claim 8, comprising additional functional descriptive material that, when executed by the computer, directs the computer to perform actions of:
accessing, from within a JAVA native method, one or more elements from the one or more inner arrays.

15. A data processing system comprising:
at least one processor;
at least one data store that is accessible to the at least one processor;
an interpreter residing in the at least one data store; and
a program residing in the at least one data store and containing an allocation instruction to dynamically allocate an array of memory in a heap,
wherein the at least one processor executes the interpreter to interpret and execute the program, and by executing the program, executes the allocation instruction, and
wherein executing the allocation instruction includes:
identifying a set of one or more blocks of free memory space, wherein each block in the set is a contiguous region of free memory space and wherein the set of blocks, collectively, has a total amount of free memory space that is at least as large as the array to be allocated;
allocating one or more inner arrays from the identified blocks;
allocating an outer array having at least as many elements as the number of inner arrays allocated; and
recording references to the inner arrays in the outer array.

16. The data processing system of claim 15, wherein executing the allocation instruction further comprises:
determining if there exists a single block of memory within the heap such that the single block itself has an amount of free memory space that is at least as large as the array to be allocated; and
including only the single block of memory in said set of blocks in response to a determination that such single block exists.

17. The data processing system of claim 16, wherein executing the allocation instruction further comprises:
compacting the heap in response to a determination that such single block does not exist.

18. The data processing system of claim 3, wherein executing the allocation instruction further comprises:
performing said identifying after compacting the heap.

19. The data processing system of claim 4, wherein executing the allocation instruction further comprises:
in response to said identifying's resulting in failure, raising an error condition.

20. The data processing system of claim 1, wherein the interpreter is a virtual machine.
